(19) United States
(12) Patent Application Publication
(10) Pub. No.: US 2025/0053951 A1
(43) Pub. Date: Feb. 13, 2025

(54) ASYNCHRONOUS PAYMENT METHOD AND SYSTEM BASED ON USER-SPECIFIED PAYMENT INFORMATION

(71) Applicant: Joo Hyung EOM, Seoul (KR)

(72) Inventor: Joo Hyung EOM, Seoul (KR)

(21) Appl. No.: 18/452,970

(22) Filed: Aug. 21, 2023

(30) Foreign Application Priority Data
Aug. 8, 2023 (KR) 10-2023-0103248

(51) Int. Cl. G06Q 20/28; G06Q 20/12; G06Q 20/32; G06Q 20/38; G06Q 20/40

(52) U.S. Cl. CPC G06Q 20/28; G06Q 20/127; G06Q 20/3276; G06Q 20/387; G06Q 20/4014

(57) ABSTRACT

The present disclosure relates to an asynchronous payment method that includes the steps of: allowing a user to perform prearranged payment registration onto a payment server; allowing the user to request the purchase of a product of a shop system; allowing the shop system to request the payment server to perform payment; comparing the information of the prearranged payment registration with the information of the request of the payment; and performing the payment processing through the payment server.

### CROSS REFERENCE TO RELATED APPLICATION OF THE DISCLOSURE

The present application claims the benefit of Korean Patent Application No. 10-2023-0103248 filed in the Korean Intellectual Property Office on Aug. 8, 2023, the entire contents of which are incorporated herein by reference.

### BACKGROUND OF THE DISCLOSURE

### Field of the Disclosure

The present disclosure relates to an asynchronous payment method and system based on user-specified payment information that is capable of protecting a user's personal information upon the user's online or offline payment and safely performing the payment only with minimal information specified by the user.

### Background of the Related Art

Recently, online shopping becomes popular to thus increase demands for online payment types, such as credit cards, debit cards, deposits without bankbook, point payments, and the like, through personal computers, mobile devices, etc.

Accordingly, most of online shops request a user to install a separate program or to provide his or her payment types and personal information such as additional information (e.g., name, date of birth, mobile carrier information, and the like) for his or her authentication using his or her mobile number. As the payment types suggested by the respective online shops are different, the user has to inconveniently input the payment types and personal information whenever he or she uses online shops, and further, the user can't help worrying about the safe storage/processing of his or her personal information and payment types inputted to individual sites. However, unfortunately, leakage accident damages due to bad management of personal information and payment type information are made every year on individual online shops, thereby making users feel insecure.

As various types of easy payment applications have appeared, recently, the user performs payment with payment type information including card information initially registered through a user app, and accordingly, the leakage risk of the payment type information may be somewhat reduced. However, the leakage problems of numerous pieces of personal information (name, date of birth, mobile number, address, and the like) inputted upon the sign-up for online shops still depend upon only the information protection and management performance of the individual online shops.

In the case of payment in an offline shop, for example, using a credit card or debit card, there is a signature field on the back of the card, but it is realistically impossible that payment with a lost card or someone's card using the signature information can be prevented. Further, card duplication through copying of magnetic information upon the payment with the card or card number theft cannot be still prevented. Accidents where information of cards with which payment is performed overseas leaks and is thus illegally used frequently take place repeatedly, and accordingly, the offline payment is of course in a weak situation of card theft.

### SUMMARY OF THE DISCLOSURE

Accordingly, the present disclosure has been made in view of the above-mentioned problems occurring in the related art, and it is an object of the present disclosure to provide an asynchronous payment method and system based on user-specified payment information that is capable of basically preventing a user's personal information and payment type information from being unnecessarily distributed and stored when the user performs payment with a given payment type on an online or offline shop and allowing the user's personal information provided to a shop where a product is purchased by the user to be controlled by the user to prevent occurrence of damage and unfair transaction caused by the leakage of his or her personal information and payment type information.

To accomplish the above-mentioned objects, according to the present disclosure, there is provided an asynchronous payment method based on user-specified payment information including the steps of: allowing a user to pre-register information of at least one or more payment types onto a payment server; allowing the user to select one of the at least one or more payment types whenever the user purchases a product or service in a shop system, to input prearranged payment registration information including payment amount limit and payment expiration time determined according to the product or service to be purchased by him or her to the payment server, and to request prearranged payment registration through which payment is activated with the selected payment type during the payment expiration time; if a prearranged payment registration serial number matching the prearranged payment registration information is generated and received according to the prearranged payment registration, allowing the user to input the prearranged payment registration serial number to the shop system to request the purchase for the product or service; and if the prearranged payment registration serial number and payment information including payment amount are transmitted from the shop system to the payment server within the payment expiration time, allowing the payment server to perform payment processing according to whether the prearranged payment registration information matches the payment information.

According to the present disclosure, desirably, after the user pre-registers the user's specified payment information as a phrase arbitrarily specified by him or her onto the payment server, in the step of performing the prearranged payment registration if the payment processing with the user-specified payment information may be selected, the user may input the user-specified payment information upon the request of the purchase in the shop system to allow the shop system and the payment server to perform the user identification based on the user-specified payment information.

According to the present disclosure, desirably, the payment expiration time may be a predetermined fixed time.

According to the present disclosure, desirably, in the step of performing the prearranged payment registration, the prearranged payment registration information based on the information provided by the shop system may be set.

According to the present disclosure, desirably, the payment expiration time may be set as the remaining time of an event with time limit that occurs in the shop system.

According to the present disclosure, desirably, the payment amount limit may be set within the amount required for joining in an event occurring in the shop system.

According to the present disclosure, desirably, in the step of performing the prearranged payment registration, the user may receive information of at least one or more discount coupons applicable to the product or service to be purchased from the shop system, select and register the discount coupon he or she desires to be applied to the product or service, and transmit the information of the selected discount coupon to the shop system upon the payment processing, so that the payment processing in which the selected discount coupon is applied to the payment amount may be made.

According to the present disclosure, desirably, in the step of performing the prearranged payment registration, the identification information of the shop system may be inputted, and after the identification information of the shop system may be checked, if the information of the shop system inputted by the user may be different from the identification information of the shop system checked, the payment server may provide a notification for the user.

According to the present disclosure, desirably, if the payment processing may be completed, the payment server may transmit a payment processing completion response and at least one of delivery address and contact to the shop system.

According to the present disclosure, desirably, if the shop system may be an offline shop, the prearranged payment registration serial number generated from the payment server may be transmitted to the form of QR code to the user, and the user may scan the QR code on a terminal of the shop system to request the purchase for the product or service.

### BRIEF DESCRIPTION OF THE DRAWINGS

The above and other objects, features and advantages of the present disclosure will be apparent from the following detailed description of the embodiments of the disclosure in conjunction with the accompanying drawings, in which:

FIG. 1 is a schematic view showing a configuration of an asynchronous payment system based on user-specified payment information according to the present disclosure;

FIG. 2 is a block diagram showing a configuration of a payment server of the payment system of FIG. 1;

FIG. 3 is a block diagram showing a customer management part of FIG. 2;

FIG. 4 is a block diagram showing a prearranged payment registration management part of FIG. 2;

FIG. 5 is a flowchart showing an asynchronous payment based on user-specified payment information according to the present disclosure; and

FIG. 6 is a flowchart showing data transmission and reception relation of the payment method of FIG. 5.

### DETAILED DESCRIPTION OF THE EMBODIMENTS

Hereinafter, an embodiment of the present disclosure will be explained in detail with reference to the attached drawings wherein the corresponding parts in the embodiments of the present disclosure are indicated by corresponding reference numerals and the repeated explanation on the corresponding parts will be avoided. The term ‘modules’ and parts' as used herein are intended to refer to the unit processing at least one function or operation. If it is determined that the detailed explanation on the well known technology related to the present disclosure makes the scope of the present disclosure not clear, the explanation will be avoided for the brevity of the description. The present disclosure may be modified in various ways and may have several exemplary embodiments. Specific exemplary embodiments of the present disclosure are illustrated in the drawings and described in detail in the detailed description. However, this does not limit the disclosure within specific embodiments and it should be understood that the disclosure covers all the modifications, equivalents, and replacements within the idea and technical scope of the disclosure.

In this application, terms, such as “comprise”, “include”, or ‘have”, intended to designate those are characteristics, numbers, steps, operations, elements, or parts which are described in the specification, or any combination of them that exist, and it should be understood that they do not preclude the possibility of the existence or possible addition of one or more additional characteristics, numbers, steps, operations, elements, or parts, or combinations thereof.

Hereinafter, an explanation on an embodiment of the present disclosure will be given in detail with reference to the attached drawings.

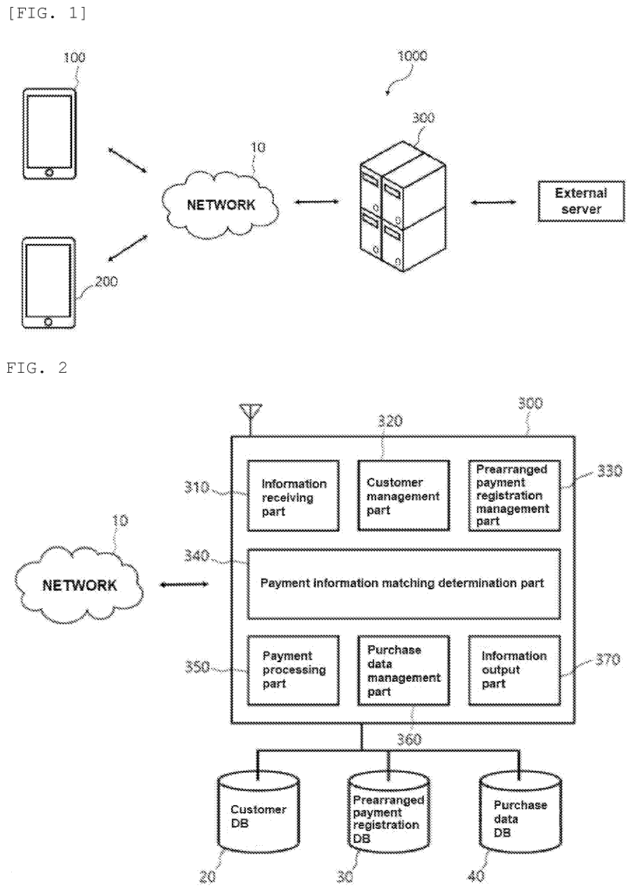

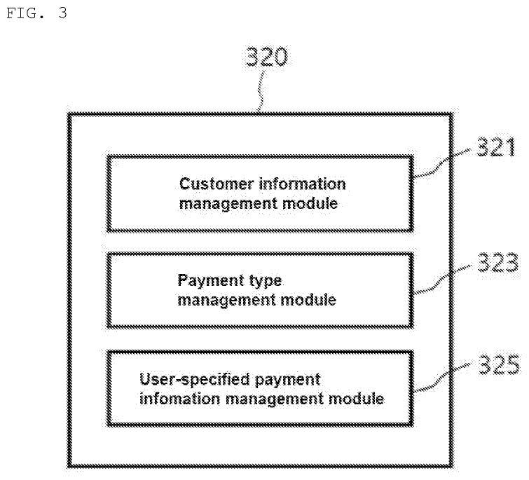

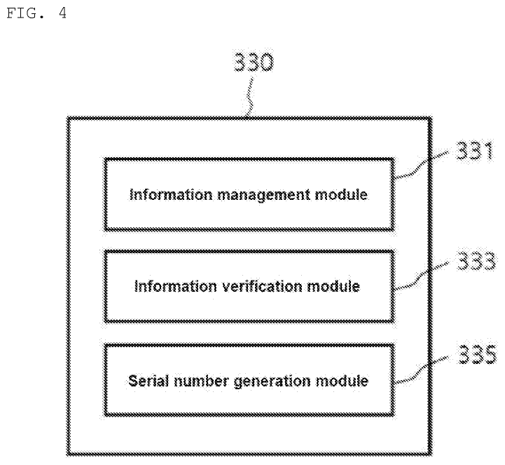

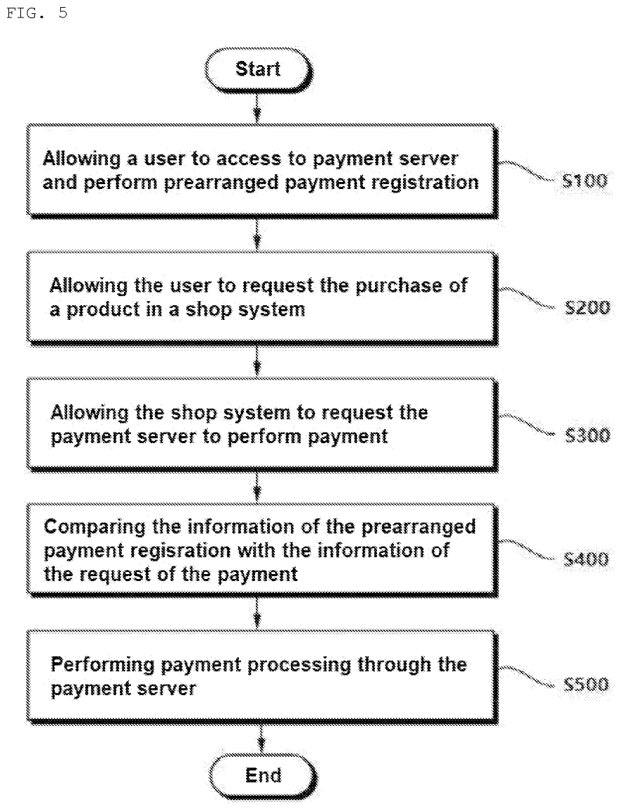

FIG. 1 is a schematic view showing a configuration of an asynchronous payment system based on user-specified payment information according to the present disclosure, FIG. 2 is a block diagram showing a configuration of a payment server of the payment system of FIG. 1, FIG. 3 is a block diagram showing a customer management part of FIG. 2, and FIG. 4 is a block diagram showing a prearranged payment registration management part of FIG. 2.

Referring to FIGS. 1 to 4, a payment system 1000 according to the present disclosure is configured to perform, if user-specified payment information and payment type information are registered by a user, the management of the registered information, to allow the user to perform prearranged payment registration onto a payment server if the user desires to purchase a product or service on an online or offline shop, and to allow, if a prearranged payment registration serial number responding to the prearranged payment registration is issued by the payment server, the user to input the issued prearranged payment registration serial number to the online shop or to scan QR code generated according to the prearranged payment registration serial number on the offline shop to make a request for the purchase of the product or service.

In specific, the payment system 1000 includes a user terminal 100, a shop terminal 200, and a payment server 300 communicating with the user terminal 100 and the shop terminal 200 through a network 10 to provide an asynchronous payment service. However, the payment system 1000 of FIG. 1 just shows an embodiment of the present disclosure, and therefore, the scope of the present disclosure is not limited in the embodiment as shown in FIG. 1.

The payment system 1000 includes an external server as a payment agency server that processes the user's payment with the payment type through which the user's payment is performed through the payment server 300. The external server may be a server of a card company, a bank, a point issuing company, and phone bill or a server of a mobile carrier affiliated with the payment system 1000 according to a credit card, a debit card, deposit without bankbook, point payment, and the like (hereinafter, referred collectively to as ‘payment types’).

That is, the payment system 1000 of the present disclosure is affiliated with a payment agency, and if there is a request of authentication or payment, the payment system 1000 transmits authentication or payment information to the external server through a client program and API linked with the external server as the server of the payment agency. If the authentication and payment procedures are executed and completed in the external server, the external server transmits the completed information to the payment server 300 of the payment system 1000. The corresponding process is a general process for the approval for the payment, which is out of the scope of the present disclosure, and accordingly, a specific explanation of the process will be avoided. In the embodiment of the present disclosure, as described above, the payment system 1000 includes the external server additionally, but the present disclosure may not be limited thereto. The payment server 300 and the external server may be the same as each other.

The user terminal 100 is a computer or mobile terminal held by a person (hereinafter, referred to as a user) who desires to purchase a product or service chosen in an online or offline shop through the payment system 1000, and the user accesses to the payment server 300 through the network 10 to the form of web, application, or web application and thus signs up for the payment system 1000.

Further, the user inputs user information for signing up for the payment system 1000, such as email address, identification (ID), mobile number, password, and the like and then inputs the information of at least one or more payment types, through the user terminal 100, so that as the user information and the payment type information are registered onto the payment server 300, he or she performs the payment.

Furthermore, the user inputs the user-specified phrase for the payment through the user terminal 100 and registers the user-specified phrase onto the payment server 300, so that if he or she does not desire to expose the email address or mobile number to the online or offline shop, he or she performs the payment through the user-specified phrase. The procedure will be explained later.

When the payment occurs on the online or offline shop, the payment system 1000 according to the present disclosure is configured to allow the payment server 300 to relay the user and a shop system, instead of the conventional method wherein the payment is made after the user information and the payment type information have been directly inputted to the online or offline shop system.

Accordingly, the payment system 1000 according to the present disclosure prevents the user's personal information and payment type information from being exposed, executes the request of payment only with minimal information, and induces the user to provide minimal information when he or she signs up for the shop system. As a result, the shop also has a simple procedure of membership and reduces the risks of storing and handling the personal information and the endeavors in managing the personal information.

Before the user performs the payment for his or her desired product or service in the shop system through the user terminal 100, further, the user accesses to the payment server 300 through the application, web, or web application provided by the payment system 1000 and registers payment amount and payment expiration time onto the payment system 1000 to perform prearranged payment registration. The procedure will be explained in detail later when the payment server 300 is described.

The shop terminal 200 is a computer, a mobile terminal, or a kiosk device held by a person (hereinafter, referred to as a ‘seller’) who sells a product or service in an online or offline shop. The shop terminal 200 accesses to the payment server 300 through the network 10 on the payment system 1000 to request the payment, and if the approval for the payment is checked, the shop terminal 200 provides the product or service for the user. In the case of the online shop, for example, the seller receives delivery information and sends the product out to the user according to the corresponding delivery information, and in the case of the offline shop, the seller scans the QR code from the user terminal 100 through the shop terminal 200, and if the approval for the payment according to the corresponding information is checked, the seller provides the product or service for the user on the spot.

In the case of the online shop, further, the shop terminal 200 is a management terminal or server that is managed through a shop system such as an online shopping mall, and in the case of the offline shop, the shop terminal 200 is a management terminal or a payment terminal or server that is built in the shop and linked with a point of sale (POS) system of the shop system of the shop. The shop system managed through the shop terminal 200 is not limited in types and shapes. For example, the shop system includes home shopping, live shopping, SNS shopping, joint purchasing with time limits, time attack shopping, and the like.

The seller signs up for the payment system 1000 and adopts the client program and API linked with the payment server 300 to the shop system. If a payment request is made from the user, the seller transmits the information provided by the user to the payment server 300. Next, authentication and payment procedures are performed by the payment server 300, and if the authentication and payment procedures are completed, the payment server 300 transmits the completed information to the shop terminal 200. Before the user accesses to the shop system to purchase the product or service, that is, the user accesses to the payment server 300 through the client provided by the payment server 300 and thus performs the prearranged payment registration. The corresponding client is independent of the shop system or connected to the shop system through a link with a client provided by the shop system.

The seller signs up for the payment system 1000 in the unit of the shop system, and the seller registers shop identification ID for identifying the shop system onto the payment system 1000. That is, in the case where a plurality of shop terminals 200 are handled in the shop system, even if the payment is made through any shop terminal 200, the payment system 1000 identifies the shop system as the same shop system through the shop ID.

In this case, it is assumed that the registered shop ID is the shop ID matching a shop name and shop URL domain information exposed to the user on the web, application, or web application linked with the online or offline shop system selling the product or service to be paid by the user. In this case, the shop ID or the shop name or URL domain information matching the shop ID is inputted to the payment server 300 in a process where the user performs the prearranged payment registration onto the payment server 300. After that, if the shop system requests the payment server 300 to perform the payment according to the user's purchase request on the online or offline shop, it is determined whether the payment is approved or not according to whether the shop ID corresponds to the shop information. In specific, the shop ID or the shop information matching the shop ID is utilized for the payment authentication process. The shop ID is constituted of serial shop codes and guessed from URL address or domain name. Otherwise, the shop ID may be an identification code based on a shop name, a mail-order-sales registration number, or a business registration number.

Further, the user inputs prearranged payment registration serial number issued from the payment server 300 to the online shop according to the prearranged payment registration, and otherwise, the user scans the QR code generated according to the issued prearranged payment registration serial number in the offline shop, thereby requesting the purchase for the product or service. After that, the shop system transmits the user identifying information and the shop information, such as the user-specified payment information, the prearranged payment registration serial number, the shop information, the product information, the amount information, and the like to the payment server 300 and requests the payment for the product. That is, the payment server 300 compares the information of the prearranged payment registration inputted by the user with the information provided by the shop system, and if they correspond to each other, the payment server 300 receives the payment approval from the external server of the payment agency and performs the payment processing. Next, the payment server 300 informs the shop system of the payment processing result.

When the payment is made on the online or offline shop, that is, the payment system 1000 according to the present disclosure is configured to allow the payment server 300 to relay the shop system and the external server of the payment agency, instead of the conventional method wherein the payment is made through the external server of the payment agency after the payment type information has been directly inputted onto the online or offline shop system. Accordingly, the payment can be made, even though the payment type information or the personal information is not provided to the shop even upon the online or offline payment, thereby preventing the payment type information from being stolen and illegally used.

Further, the computers for the user terminal 100 and the shop terminal 200 include a desktop, a laptop, a table PC, and the like, in which a web browser is built, and the mobile terminals for the user terminal 100 and the shop terminal 200, as wireless communication devices ensuring portability and mobility, include all types of handheld-based wireless communication devices such as a smartphone, a personal communication system (PCS), a global system for mobile communication (GSM), a personal digital cellular (PDC) system, a personal handy-phone system (PHS), a personal digital assistant (PDA), international mobile telecommunication (IMT)-2000, code division multiple access (CDMA)-2000, W-code division multiple access (W-CDMA), wireless broadband internet (Wibro), and the like. Upon the payment on the offline shop, in this case, the user terminal 100 is a mobile terminal.

Further, the network 10 for connecting the user terminal 100 and the shop terminal 200 to the payment server 300 includes all types of wired/wireless networks such as local area network (LAN), wide area network (WAN), value added network (VAN), personal area network (PAN), mobile radio communication network, Wibro, mobile WiMAX, high speed downlink packet access (HSDPA), and satellite communication network.

The payment server 300 accesses to the user terminal 100 and the shop terminal 200 through the network 10, and if the user-specified payment information and the payment type information are registered from the user terminal 100, the payment server 300 manages the registered information. After that, if the prearranged payment registration onto the payment server 300 is performed by the user terminal 100, the payment server 300 issues the prearranged payment registration serial number according to the process of the prearranged payment registration and transmits the issued prearranged payment registration serial number to the user terminal 100, so that the user performs the payment on the online or offline shop using the prearranged payment registration serial number and the user-specified payment information.

After that, the shop system transmits the user-specified payment information and the prearranged payment registration serial number provided by the user to the payment server 300 and requests the payment server 300 to perform the payment. That is, the payment server 300 checks the information received from the shop system and thus compares the information of the prearranged payment registration inputted by the user with the information received from the shop system, and if they correspond to each other, the payment server 300 receives the payment approval from the external server of the payment agency and performs the payment processing. Next, the payment server 300 informs the shop system of the payment processing result.

Now, an explanation of the payment server 300 according to the present disclosure will be given in detail with reference to FIGS. 2 to 4.

Referring to FIGS. 2 to 4, the payment server 300 includes an information receiving part 310, a customer management part 320, a prearranged payment registration management part 330, a payment information matching determination part 340, a payment processing part 350, a purchase data management part 360, and an information output part 370.

The information receiving part 310 serves to receive information from the user terminal 100 and the shop terminal 200 through the network 10. For example, the information receiving part 310 communicates with the user terminal 100 and the shop terminal 200 and receives customer information including basic information through the sign-up for the payment system 1000. Further, the information receiving part 310 receives the payment type information from the user.

Further, the information receiving part 310 receives the information necessary for the prearranged payment registration from the user terminal 100 in the step of the prearranged payment registration and communicates with the shop terminal 200 and the external server in the step of the payment processing to thus receive the information of payment processing for the product or service requested to be paid by the user from the shop system and the information of payment approval from the external server. In this case, the received information is information directly inputted or extracted from specific information. For example, the information extracted by decoding encrypted code is received.

The customer management part 320 serves to register and manage as customers at least one or more users and sellers that sign up for the payment system 1000. The singing up for the payment system 1000 is performed through application, web, or web application related to payment provided by the payment system 1000. Further, the customer management part 320 manages the information necessary for the user's purchase request and payment processing. In specific, the customer management part 320 includes a customer information management module 321, a payment type management module 323, and a user-specified payment information management module 325.

The customer information management module 321 serves to store and manage the user information such as a name, a phone number, an email, ID, email address, mobile number, a password, and the like inputted from the user terminal 100. If the user signs up for the payment system 1000, the customer information management module 321 applies a user ID code by user, matches the applied user ID code with the user information inputted, and stores and manages the matching result in a customer database (DB) 20.

Further, the customer information management module 321 serves to store and manage seller information including basic information such as a name, phone number, and email address, information of the shop system operating by the seller, and the like inputted from the shop terminal 200. If the seller signs up for the payment system 1000, the customer information management module 321 applies a seller ID code by seller, matches the applied seller ID code with the seller information inputted, and stores and manages the matching result in the customer DB 20. Further, the customer information management module 321 stores and manages shop ID, shop name, and the like according to the shop system registered by the seller. In the case of the online shop, URL address of the web and application name and ID number of the shop system on the application are stored and managed.

According to the present disclosure, further, the customer management part 320 stores and manages the user information and the seller information in the customer DB 20, but it may store and manage them in respective DBs, without being limited thereto.

The payment type management module 323 serves to store and manage information of at least one or more payment types of the user. The payment type management module 323 manages the information of at least one or more payment types by user. The information of the at least one or more payment types is the information necessary for payment. In the case of deposit without bankbook, the information includes the account number and password registered on a bank, and in the case of card payment, the information includes the card number, expiration date information, CVC/CVV information, and card bill address information registered by the user. In the case of point payment, the information includes point type, password, and the like.

The payment type management module 323 manages the payment type information through security processing and is thus involved in the payment, while referring to the payment type information upon the payment processing. However, the payment type management module 323 may not be limited thereto. The payment type information inputted upon the registration is stored in the external server linked with the payment server 300, such as a server of a Payment Gateway (PG) company, in the case of card information, and next, the payment type management module 323 receives and stores a responded card profile ID value from the server of the PG company and then requests the card payment using the corresponding value.

In this case, the payment approval password, the mobile number, the email address, and the user-specified phrase, which are used in the payment, are all one-way encrypted and stored, and accordingly, no personal information or payment type information are not left in the payment server 300.

The user-specified payment information management module 325 manages the user-specified payment information through which the user is identified according to the information arbitrarily specified by the user to thus perform the payment processing.

So as to perform payment, in specific, the user inputs the user-specified payment information through the user terminal 100 and registers the information onto the payment server 300, and the user-specified payment information management module 325 registers the user-specified phrase by user and manages the registered user-specified phrase.

That is, the user specifies the information registered upon the singing up for the payment system 1000, such as, the phone number or the email address as the user-specified payment information upon his or her request of the purchase in the online or offline shop, and if the user does not desire to expose the email address or the mobile number to the online or offline shop, he or she registers the user-specified phrase (hereinafter, referred to as ‘user-specified payment information’) to be used for the payment, instead of the phone number or the email address. The corresponding information is the information for identifying the user and handled as a kind of ID. That is, the user-specified payment information is used to identify the user who requests the payment between the shop system and the payment server 300.

In this case, the user-specified payment information includes a specific phrase having at least one of characters of all languages, numbers, and special characters inputted to the payment system 1000. The specific phrase includes meaningful words or sentences, such as, Flex, Hi, Nice to meet you, Feel good, Stop swiping your credit card, and the like, character strings arranged with meaningless characters inputted by a keyboard, and the like. Otherwise, the information arbitrarily produced and provided by the payment server 300 is specified as the user-specified payment information, if so desired by the user. That is, the user-specified payment information is specified as the personal information such as the phone number, the email address, and the like or the arbitrary information specified by the payment system 1000.

The user-specified payment information is used to identify the user when the shop system requests the payment server 300 for the payment, and accordingly, it is handled as a kind of ID. If users who make use of the same phrase and have corresponding identification information such as payment type information used for the user identification do not exist, the corresponding phrase as the user-specified phrase is registered onto the payment server 300 and thus managed. If the user-specified payment information is inputted upon the user's purchase request, further, the shop system requests additional information to the corresponding phrase that is necessary for the user identification, for example, information in an openable range of the payment type, such as the last four digits of the card number, and the shop system transmits the corresponding information to the payment server 300. Accordingly, the payment server 300 identifies the user who requests the payment, based on the combination of the information.

When the user requests the purchase for the desired product or service in the shop system, accordingly, the payment server 300 allows the user to input the user-specified phrase to the shop and thus identifies the user through the user-specified payment information when the shop system requests the payment server 300 to perform the payment. The user-specified payment information is changed through the user terminal whenever the user wants, and accordingly, even if the user-specified payment information is stored arbitrarily in the online or offline shop and exposed to the outside to thus cause a security incident, the user can change the exposed user-specified payment information through the user terminal whenever he or she wants, so that there is no need to cancel or reissue his or her credit card due to the security incident.

The user-specified payment information has been explained as the phone number, the email address, or the user-specified character string to be used for the payment, but the information may not be limited thereto. The user-specified payment information is the information for user identification when the shop system requests the payment server 300 to perform the payment, and accordingly, the email address or phone number of the user that is already recognized by the shop system through the sign-up of the user may be set as basic user-specified payment information. In this case, the user-specified payment information is determined by the selection of the user in the same manner where the user selects the payment with the user's specified payment information arbitrarily specified by him or her.

If the user desires to purchase the product or service in the online or offline shop and thus accesses to the payment server 300 through the user terminal 100 to complete the prearranged payment registration, the prearranged payment registration management part 330 manages the information of the prearranged payment registration for a given valid time, performs the verification of the user and the shop according to the information of the prearranged payment registration, and if the verification is completed, generates the prearranged payment registration serial number according to the prearranged payment registration, and transmits the prearranged payment registration serial number to the user terminal 100. After that, the user requests the payment in the online and offline shop using the prearranged payment registration serial number.

In specific, the prearranged payment registration management part 330 includes an information management module 331, an information verification module 333, and a serial number generation module 335.

The information management module 331 manages the information of the prearranged payment registration inputted through the user terminal 100 in the step of the prearranged payment registration. The information of the prearranged payment registration includes selection information for a payment type with which the payment is performed among at least one or more payment types, payment expiration time information, payment amount limit information, and payment approval password of the selected payment type. Further, the information of the prearranged payment registration includes information of the shop that performs the payment, product information, and product price information. The information of the prearranged payment registration is stored and managed in a prearranged payment registration DB 30 during the payment expiration time. If the user requests the payment in a state where the payment expiration time designated upon the prearranged payment registration passes, accordingly, the information of the prearranged payment registration is deleted in the prearranged payment registration DB 30, so that the request of the payment is rejected. That is, the payment server 300 manages the information of the prearranged payment registration as volatile information that is stored only during the payment expiration time, and accordingly, even if a security incident occurs in the shop system to cause information to leak or the information of the payment server 300 leaks, unwanted payment can be prevented from being made.

In specific, if the online shop system is used by the user, the user executes the application, web, or web application provided by the payment system 1000 and selects online payment and the payment type, and if the offline shop system is used by the user, the user executes the application or web application provided by the payment system 1000, to which his or her mobile is accessible, and selects offline payment and the payment type. Further, the user selects the user-specified payment information specified for the corresponding payment type, sets the payment expiration time and payment amount limit, and inputs the payment approval password for the payment through the payment type, thereby executing the request of the prearranged payment registration. Before the user requests the purchase for the product or service in the shop system, that is, he or she accesses to the payment server 300, inputs the prearranged payment registration information including the payment amount limit and the payment expiration time, selects one of at least one or more payment types, and activates the payment with the selected payment type during the payment expiration time, thereby performing the prearranged payment registration.

The payment expiration time is time during which the prearranged payment registration is kept, and after the prearranged payment registration, the user has to perform the payment in the online or offline shop within the payment expiration time so as to success the payment. The payment expiration time is set as a predetermined short time by the user to prevent brute-force attack of a malicious attacker from happening. For example, the payment expiration time is set as 30 seconds. Otherwise, the payment expiration time based on the information of the product registered by the user is set. That is, the information of the prearranged payment registration is set, while being based on the information provided by the shop system.

For example, the payment expiration time may be set as the remaining time of an event with time limit that occurs in the shop system. In specific, in the case of the product to which a discount coupon with time limit is applied upon the occurrence of an event for the product in the online or offline shop, the remaining time of the event is set as the payment expiration time to apply the discount coupon to the product. In this case, for example, information of the discount coupon such as a coupon name, a discount rate, a coupon product, and information of time remaining is registered as the information of the prearranged payment registration. However, the corresponding information may not be limited thereto. The payment expiration time is set as a short period of time, but if the payment expiration time is within the remaining time of the event for application of the discount coupon, the payment server 300 informs the user that he or she gets the discount coupon to thus allow him or her to pay the price of the product at the discounted price.

The payment amount limit is the maximum of the payment amount in the online or offline shop, and the user can perform the payment within the corresponding payment amount limit in the online or offline shop. Further, the payment amount limit is set within the payment amount of the product or service for which the prearranged payment registration is performed or by the user. After a product to be paid is determined, for example, if the prearranged payment registration for a plurality of products is performed, the payment amount limit is determined as the sum of the payment amounts of the plurality of products. Contrarily, if a product to be paid is not determined, the user sets a given amount within the payment amount limit and pays the prices of the plurality of products within the payment amount limit. In the case of the latter, the payment amount limit for the prearranged payment registration may be different from the payment amount made really in the online or offline shop.

As various coupons are applied, further, the payment amount limit for the prearranged payment registration may be different from the payment amount made really in the online or offline shop. For example, a plurality of discount coupons are issued by shop system under the conditions of events such as a sign-up event, a first payment event, a birthday event, and the like, and the user inputs shop information and product information to allow the information of the plurality of discount coupons applicable to be automatically registered. When the user performs the payment for the product or service, accordingly, the payment server 300 performs the payment processing, based on the information of the discount coupons applied through the selection of the user, and therefore, a different payment amount that is deviated from the initial payment amount limit for the prearranged payment registration may be made. In the step of the prearranged payment registration, specific, the user receives the information of at least one or more discount coupons applicable to the product or service to be purchased from the shop system, selects and registers the discount coupons he or she desires to apply to the product or service, and transmits the selected information of the discount coupons to the shop system upon the payment processing, so that the payment processing in which the selected discount coupons are applied to the payment amount is made.

Further, the payment amount limit is set within the amount required for joining in an event occurring in the shop system. For example, the discount coupon is applicable under the condition of the payment amount limit registered by the user. In the case of a live shopping mall, only users who register the payment amount limit over a given amount can enter the shopping mall, and thus, the discount coupons are applied only to the users who purchase products over the given amount. According to the present disclosure, that is, the payment system 1000 can be effectively utilized in time attack events of online and offline shopping malls using the payment expiration time and the payment amount limit through the asynchronous payment processing.

Upon the prearranged payment registration, further, the user directly inputs the shop information where payment is made and the price to be paid, reads the shop information including the shop ID, the identification code including the product name, the product price, and the like, or QR code, which is provided by the online or offline shop, or copies and pastes digital information with different forms including the information to a prearranged payment registration window. In the case of the offline shop, the user reads a beacon signal by product to perform the prearranged payment registration with the read information.

Upon the prearranged payment registration, furthermore, the user selectively designates delivery information and requests delivery. In this case, if the payment is normally completed, the registered delivery information is transmitted to the shop system, while being included in a payment processing completion response, and the delivery information used once may be used as a basic value upon next payment, if the user wants.

According to the payment system 1000 of the present disclosure, that is, the delivery information is transmitted to the shopping mall server to system from the payment server 300 after the payment has been normally made, and accordingly, even if a malicious attacker steals the user-specified payment information and the prearranged payment registration serial number within the short payment expiration time set upon the prearranged payment registration, the ordered product can be prevented from being delivered to a shipping address desired by the attacker.

The information verification module 333 serves to verify whether the information of the prearranged payment registration is valid or not. The information verification module 333 verifies the payment type registration of the user, the user-specified payment information registration, and the payment approval password of the selected payment type, among the information of the prearranged payment registration performed by the user.

Based on the shop information inputted upon the prearranged payment registration, such as, the shop ID, shop name, shop domain name, and the like, further, the information verification module 333 determines whether the shop is the shop registered onto the customer information management module 321 and the shop information corresponds to the registered information and thus outputs the determined results to the user terminal 100. In the process, the information verification module 333 additionally checks the basic information (e.g., shop name, URL address in the case of web, and application name in the case of application) of the shop registered onto the external server of the payment agency, thereby performing the verification of the shop system.

In the step of the prearranged payment registration, that is, the shop ID of the shop system or the shop identification information such as shop name and shop domain name is inputted, and next, the identification information is checked. If the information of the shop system inputted by the user is different from the information of the shop system checked, the information verification module 333 outputs a warning message to inform the user of warning and provides a suspicious shop report function for the user.

If the information of the prearranged payment registration is verified through the information verification module 333, the serial number generation module 335 serves to generate the prearranged payment registration serial number matching the information of the corresponding prearranged payment registration. The prearranged payment registration serial number is handled as the information of the prearranged payment registration and managed in the information management module 331. The prearranged payment registration serial number generated according to the prearranged payment registration is one-time number or character temporarily generated, but it may not be limited thereto.

The prearranged payment registration serial number is transmitted to the user terminal 100, and in the case where the online shop is used by the user, if the user inputs the prearranged payment registration serial number received after he or she has selected/inputted the user-specified payment information and requests the payment, the shop system transmits the shop information, the product information, the amount information, and the user-specified payment information and the prearranged payment registration serial number through which the user is identified to the payment server 300 to request the payment server 300 to perform the payment.

Contrarily, in the case where the offline shop is used by the serial number generation module 335 additionally generates the QR code including the user-specified payment information and the prearranged payment registration serial number and transmits the QR code to the user terminal 100. In this case, the user scans the QR code on the shop terminal 200 located in the offline shop to request the purchase for the product or service, and the shop system reads the QR code. If the QR code is encrypted, the shop system decodes the encrypted QR code and reads the QR code. Next, the shop system transmits the shop information, the product information, the amount information, and the user-specified payment information and the prearranged payment registration serial number through which the user is identified to the payment server 300 to request the payment server 300 to perform the payment. That is, in the case where the online and offline shops are used by the user, the payment type information or the personal information is not provided at all to the shops upon his or her payment, thereby preventing the payment type information from being stolen and illegally used. According to the present disclosure, further, the QR code is generated and used for the request for the purchase upon the use of the offline shop, but the present disclosure may not be limited to the QR code. For example, all types of media scannable including data can be applied upon the use of the offline shop.

If the shop system transmits the user-specified payment information and the prearranged payment registration serial number received from the user terminal 100, the shop information, the product information, and the amount information according to the user's purchase request in the shop system to the payment server 300 and thus requests the payment server 300 to perform the payment, the payment information matching determination part 340 compares the information of the prearranged payment registration inputted by the user with the information provided by the shop system and thus determines whether they match each other. If the prearranged payment registration serial number and the payment information including the payment amount are received within the payment expiration time from the shop system, the payment information matching determination part 340 determines whether the information of the prearranged payment registration matches the payment information and executes the payment processing according to the determined results.

That is, the shop system transmits the user-specified payment information and the prearranged payment registration serial number received from the user terminal 100, the product information and the amount information of the product for which the payment is requested by the user, and the shop information to the payment server 300 to request the payment server 300 to perform the payment. In this case, the payment information matching determination part 340 verifies the information provided by the shop system and compares the information of the prearranged payment registration inputted by the user with the information provided by the shop system, and if they match each other, the payment information matching determination part 340 acquires the payment approval from the external server of the payment agency and performs the payment processing.

In specific, the payment information matching determination part 340 checks whether there is the information of the prearranged payment registration registered by the user who is identified with the user-specified payment information and the prearranged payment registration serial number transmitted to the shop system and thus determines whether the corresponding prearranged payment registration serial number received matches the prearranged payment registration serial number registered. Further, the payment information matching determination part 340 determines whether the request of the payment is received within the payment expiration time and the payment amount is over the payment amount limit.

If it is determined that there is no information of the prearranged payment registration registered by the user who is identified with the user-specified payment information and the prearranged payment registration serial number transmitted to the shop system or the corresponding prearranged payment registration serial number received does not match the prearranged payment registration serial number registered, the payment information matching determination part 340 rejects the request of the payment of the shop system, and if the request of the payment is not received within the payment expiration time or the payment amount is over the payment amount limit, the payment information matching determination part 340 rejects the request of the payment of the shop system.

In this case, if the request of the payment of a given user in a given shop system is rejected over the given number of times within a given period of time, the payment server 300 registers the given user onto an unpair transaction black list and does not admit the request of the payment with the payment information through which the given user is identified for a specific period of time in the given shop system. In this case, the unpair transaction black list by user is managed in the customer information management module 321. In addition, the payment server 300 provides the information of the given user on the black list who tries unpair transaction to the given shop system and thus allows the given shop system to limit his or her payment.

In the case where the shop information and the product information are registered by the user in the step of the prearranged payment registration, further, if the registered shop information and product information is different from that received from the shop system, the payment information matching determination part 340 rejects the request of the payment of the shop system.

According to the payment system 1000 of the present disclosure, upon the request of the prearranged payment registration in the asynchronous payment processing method, the information registered at the time when a franchisee is registered with the shop ID provided by the shop onto the payment agency is checked and provided to the user, and if the shop information on the user's shopping is different from the shop information checked by the shop ID, a caution and a reporting function are provided to the user to prevent some of shops from having sales/accounting fraud using different shop ID, thereby allowing the payment agency or card issuing company to clearly and reliably manage card transaction sales. Further, fraudulent transactions using fake shop information made by stealing the information of different normal shopping malls for the malicious purposes can be prevented from occurring.

The payment processing part 350 performs the payment processing if it is determined that the information of the prearranged payment registration inputted by the user matches the information provided by the shop system through the comparison in the payment information matching determination part 340. That is, the payment processing part 350 communicates with the server of the payment agency asynchronously according to the request of the payment of the shop system. For example, the server of the payment agency includes a server of a card company, a phone bill, and the like or a server of a mobile carrier affiliated. The payment processing part 350 performs the payment for the payment amount through the payment type selected by the user and further performs one-off or installment payment through the selection of the user upon the prearranged payment registration. Furthermore, the payment processing part 350 performs pre-payment with points usable in the payment system 1000 and allows the user to consume the points in using the service.

For example, the payment system 1000 of the present disclosure is affiliated with the payment agency, and if an authentication or payment request occurs from the shop system, the payment processing part 350 transmits authentication or payment information to the server of the payment agency through the client program and API linked with the server of the payment agency. If the authentication and payment procedures are executed in the server of the payment agency and thus completed, authentication or payment information such as a customer identification code (user inherent identification key), the information of the product whose price is paid by the user, the payment amount, the payment time, and the like is stored in the server of the payment agency. The payment processing part 350 receives the authentication and the payment success signal and stores the received information in the customer DB 20 or in a separate purchase data DB 40. Next, the payment processing part 350 transmits the payment information to the shop system to inform the shop system of the payment success. In this case, further, the payment server 300 transmits the delivery information of the user to the shop system.

If the payment success signal is received from the server of the payment server through the payment processing of the payment processing part 350, the purchase data management part 360 receives the payment success signal from the payment processing part 350 and stores and manages the shop information, the payment amount information, and the production information matching the information of the user who performs the payment for the product or service. Upon next prearranged payment registration of the user, accordingly, the purchase data management part 360 provides the list of the existing shops where the purchase is performed for the user, based on the shop information, or recommends the payment amount limit, based on the payment amount information.

Accordingly, the time consumed for the prearranged payment registration is reduced, and other products having correlation relation based on the purchase data are recommended. Otherwise, a payment amount limit considering the consumption habit of the user is recommended.

The information output part 370 outputs information to the user terminal 100 and the shop terminal 200 through the network 10. For example, the information output part 370 outputs a service screen to the user terminal 100 and outputs at least one or more information in the steps of the prearranged payment registration and the request of the payment to the user terminal 100, the shop terminal 200, or the external server.

If the prearranged payment registration is completed by the user, the information output part 370 outputs the information of the prearranged payment registration, such as shop information, the payment type information, and the payment amount limit information to the user terminal 100. Further, the information output part 370 outputs the information of the remaining payment expiration time to the user terminal 100.

In addition, the information output part 370 outputs the information of the result (approval or rejection) for the request of the payment from the payment server 300 to the user terminal 100 after the prearranged payment registration has been completed, and if no response is received from the payment server 300 during the payment expiration time, the information output part 370 informs the user terminal 100 that the expiration time of the case of the corresponding prearranged payment registration is up.

That is, the payment system 1000 according to the embodiment of the present disclosure performs the request of the payment only using at least personal information (e.g., phone number, email address, etc.) or non-personal information arbitrarily specified by the user upon the payment on the online shopping mall and transmits the delivery address or contact if the payment is completed, so that additional personal information (e.g., name, date of birth, address, etc.) is not provided at all upon signing up for the online shopping mall, and the shopping mall has a simple sign-up procedure and reduces the risks of storing and handling the personal information and the endeavors in managing the personal information.

Further, the information inputted in the payment processing on the online shopping mall is simplified to prevent sales from being decreased due to technical problems (plugin installation, delivery address inquiry and input, and the like) occurring during the payment processing and to thus reduce the endeavors in customer service (CS) consumed for the technical problems.

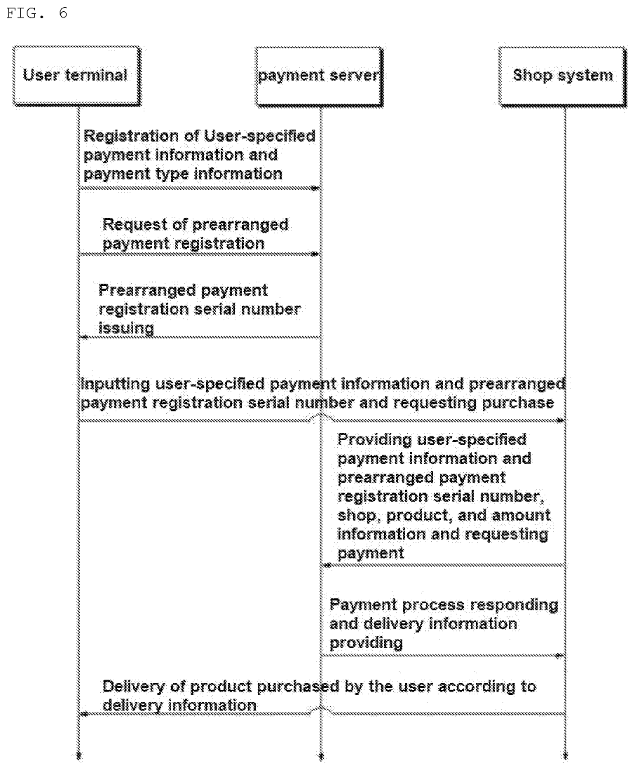

Hereinafter, an explanation of an asynchronous payment method based on the user-specified payment information according to the present disclosure will be given with reference to FIGS. 5 and 6.

FIG. 5 is a flowchart showing an asynchronous payment method based on user-specified payment information according to the present disclosure, and FIG. 6 is a flowchart showing data transmission and reception relation of the payment method of FIG. 5.

Referring to FIGS. 1 to 6, an asynchronous payment method according to the present disclosure includes the steps of allowing the user to perform the prearranged payment registration onto the payment server 300 (at step S100), allowing the user to request the purchase of the product of the shop system (at step S200), allowing the shop system to request the payment server to perform payment (at step S300), comparing the information of the prearranged payment registration with the information of the request of the payment (at step S400), and performing the payment processing through the payment server 300 (at step S500).

In the step (S100) of allowing the user to perform the prearranged payment registration onto the payment server 300, the information of the prearranged payment registration is registered onto the payment server 300 through the user terminal 100. The information of the prearranged payment registration includes selection information for a payment type with which the payment is performed among at least one or more payment types, payment expiration time information, payment amount limit information, and payment approval password of the selected payment type. Further, the information of the prearranged payment registration includes the information of the shop that performs the payment, the product information, and the product price information. The information of the prearranged payment registration is stored and managed in the prearranged payment registration DB 30 during the payment expiration time.

In specific, the user pre-registers information of at least one or more payment types onto the payment server 300, selects the user-specified payment information specified for the corresponding payment type, sets the payment expiration time and the payment amount limit, and inputs the payment approval password for the payment through the payment type, thereby executing the request of the prearranged payment registration.

The payment expiration time is time during which the prearranged payment registration is kept, and after the prearranged payment registration, the user has to perform the payment in the online or offline shop within the payment expiration time so as to success the payment. The payment expiration time is set as a predetermined short time by the user to prevent brute-force attack from happening. For example, the payment expiration time is set as 30 seconds. Otherwise, the payment expiration time based on the information of the product registered by the user is set. For example, in the case of the product to which a discount coupon with time limit is applied upon the occurrence of an event for the product in the online or offline shop, the remaining time of the event is set as the payment expiration time to thus apply the discount coupon to the product. In this case, for example, the information of the discount coupon such as a coupon name, a discount rate, a coupon product, and information of time remaining is registered as the information of the prearranged payment registration. However, the corresponding information may not be limited thereto. The payment expiration time is set as a short period of time, but if the payment expiration time is within the remaining time of the event for application of the discount coupon, the payment server 300 informs the user that he or she gets the discount coupon to allow him or her to pay the price of the product at the discounted price.

The payment amount limit is the maximum of the payment amount in the online or offline shop, and the user can perform the payment within the corresponding payment amount limit in the online or offline shop. Further, the payment amount limit is set within the payment amount of the product or service for which the prearranged payment registration is performed or by the user. After a product to be paid is determined, for example, if the prearranged payment registration for a plurality of products is performed, the payment amount limit is determined as the sum of the payment amounts of the plurality of products. Contrarily, if a product to be paid is not determined, the user sets a given amount as the payment amount limit and pays the prices of the plurality of products within the payment amount limit. In the case of the latter, the payment amount limit for the prearranged payment registration may be different from the payment amount made really in the online or offline shop.

As various coupons are applied, further, the payment amount limit for the prearranged payment registration may be different from the payment amount made really in the online or offline shop. For example, a plurality of discount coupons are issued by shop system under the conditions of events such as a sign-up event, a first payment event, a birthday event, and the like, and the user inputs shop information and product information to allow the information of the plurality of discount coupons applicable to be automatically registered. When the user performs the payment for the product or service, accordingly, the payment server 300 performs the payment processing, based on the information of the discount coupons applied through the selection of the user, and therefore, a different payment amount that is deviated from the initial payment amount limit for the prearranged payment registration may be made.

Further, the discount coupon is applicable under the condition of the payment amount limit registered by the user. In the case of a live shopping mall, for example, only users who register the payment amount limit over a given amount can enter the shopping mall, and thus, the discount coupons are applied only to the users who purchase the products over the given amount. According to the present disclosure, that is, the payment system 1000 can be effectively utilized in time attack events of online and offline shopping malls using the payment expiration time and the payment amount limit through the asynchronous payment processing.

In the step (S100) of allowing the user to perform the prearranged payment registration onto the payment server, furthermore, the user selectively designates delivery information and requests delivery. In this case, if the payment is normally completed, the registered delivery information is transmitted to the shop system, and the delivery information used once may be used as a basic value upon next payment, if the user wants.

In the step (S200) of allowing the user to request the purchase of the product of the shop system, if it is determined that the information of the prearranged payment registration is valid, the prearranged payment registration serial number matching the information of the corresponding prearranged payment registration is generated and transmitted to the user terminal 100. In this case, the user selects/inputs user-specified payment information to the shop system, inputs the prearranged payment registration serial number, and requests the purchase of the product.

In specific, if the user desires to purchase the product or service in the online or offline shop, he or she performs the prearranged payment registration onto the payment server 300, and if the prearranged d payment registration serial number responding to the prearranged payment registration is issued by the payment server 300, the user inputs the issued prearranged payment registration serial number to the online shop or scans QR code generated according to the prearranged payment registration serial number in the offline shop, thereby requesting the purchase of the product or service.

In specific, in the case where the online shop is used by the user, if the user inputs the prearranged payment registration serial number received after he or she has selected/inputted the user-specified payment information to the shop system and then requests the payment, the shop system transmits the shop information, the product information, the amount information, and the user-specified payment information and the prearranged payment registration serial number through which the user is identified to the payment server 300 to request the payment server 300 to perform the payment.

Further, in the case where the offline shop is used by the user, the serial number generation module 335 additionally generates the QR code including the user-specified payment information and the prearranged payment registration serial number and transmits the QR code to the user terminal 100. In this case, the user scans the QR code on the shop terminal 200 located in the offline shop to request the purchase for the product or service, and the shop system reads the QR code. If the QR code is encrypted, the shop system decodes the encrypted QR code and reads the QR code. Next, the shop system transmits the shop information, the product information, the amount information, and the user-specified payment information and the prearranged payment registration serial number through which the user is identified to the payment server 300 to request the payment server 300 to perform the payment. That is, in the case where the online and offline shops are used by the user, the payment type information or the personal information is not provided at all to the shops upon his or her payment, thereby preventing the payment type information from being stolen and illegally used.

In the step (S300) of allowing the shop system to request the payment server to perform the payment, if the request of the purchase is made by the user, the shop system transmits the shop information, the product information, the amount information, and the user-specified payment information and the prearranged payment registration serial number through which the user is identified to the payment server 300 to request the payment server 300 to perform the payment.

In the step (S400) of comparing the information of the prearranged payment registration with the information of the request of the payment, if the shop system transmits the user-specified payment information and the prearranged payment registration serial number received from the user terminal 100, the shop information, the product information, and the amount information to the payment server 300 to request the payment server 300 to perform the payment according to the user's purchase request in the shop system, the information of the prearranged payment registration inputted by the user is compared with the information provided by the shop system to determine whether they match each other.

That is, the shop system transmits the user-specified payment information and the prearranged payment registration serial number received from the user terminal 100, the product information and the amount information of the product for which the payment is requested by the user, and the shop information to the payment server 300 to request the payment server 300 to perform the payment. In this case, the payment information matching determination part 340 verifies the information provided by the shop system and compares the information of the prearranged payment registration inputted by the user with the information provided by the shop system, and if they match each other, the payment information matching determination part 340 acquires the payment approval from the external server of the payment agency and performs the payment processing.

In the step (S500) of performing the payment processing through the payment server, if it is determined that the information of the prearranged payment registration inputted by the user matches the information provided by the shop system through the comparison in the step (S400) of comparing the information of the prearranged payment information with the information of the request of the payment, the payment processing is performed. That is, the payment processing part 350 communicates with the server of the payment agency asynchronously according to the request of the payment of the shop system. For example, the server of the payment agency includes a server of a card company, a phone bill, and the like or a server of a mobile carrier affiliated. In the step (S500), the payment processing part 350 performs the payment for the payment amount through the payment type selected by the user and further performs one-off or installment payment through the selection of the user upon the prearranged payment registration. Furthermore, the payment processing part 350 performs pre-payment with points usable in the payment system 1000 and allows the user to consume the points in using the service.

For example, in the step (S500), the payment system 1000 is affiliated with the payment agency, and if an authentication or payment request occurs from the shop system, the payment processing part 350 transmits authentication or payment information to the server of the payment agency through the client program and API linked with the server of the payment agency. If the authentication and payment procedures are executed in the server of the payment agency and thus completed, authentication or payment information such as a customer identification code (user inherent identification key), the information of the product whose price is paid by the user, the payment amount, the payment time, and the like is stored in the server of the payment agency. The payment processing part 350 receives the authentication and the payment success signal and stores the received information in the customer DB 20 or the purchase data DB 40. Next, the payment processing part 350 transmits the payment information to the shop system to inform the shop system of the payment success. In this case, further, the payment server 300 transmits the delivery information of the user to the shop system.

As described above, the asynchronous payment system according to the present disclosure can perform the request for the payment only using minimal personal information (e.g., phone number, email address, etc.) or arbitrary phrase specified by the user upon the payment on the online shopping mall and transmits the user's personal information such as the delivery address or contact to the shop system if the payment is completed, so that advantageously, additional personal information (e.g., name, date of birth, address, etc.) is not provided at all upon signing up for the online shopping mall, and the shopping mall has a simple sign-up procedure and reduces the risks of storing and handling the personal information and the endeavors in managing the personal information.

Further, the asynchronous payment system according to the present disclosure can allow the information inputted in the payment processing on the online shop to be simplified to prevent sales from being decreased due to technical problems (plugin or app installation, delivery address inquiry, etc.) occurring during the payment processing, thereby reducing the endeavors in customer service (CS) consumed for the technical problems.

Furthermore, the asynchronous payment system according to the present disclosure can allow the delivery information to be transmitted to the server of the shop system from the payment server after the payment has been normally made, so that even if a malicious attacker tries to purchase the product through a given online shop within the payment expiration time under the worst situation where the user-specified payment information and the prearranged payment registration serial number provided by the payment system are exposed to the malicious attacker, the product ordered by the malicious attacker can be prevented from being delivered to a shipping address desired by him or her.

Moreover, the asynchronous payment system according to the present disclosure can perform the payment processing through the user-specified payment information where the user's personal information is not included, so that even if the user-specified payment information is stored arbitrarily in the online or offline shop and exposed to the outside to thus cause a security incident, the user can change the exposed user-specified payment information through the user terminal whenever he or she wants, thereby having no need to cancel or reissue his or her credit card due to the security incident.

Further, the asynchronous payment system according to the present disclosure can perform the payment, without any exposure of a physical card or card number even on the offline payment, thereby preventing the payment type information from being stolen and thus used illegally.

In addition, the asynchronous payment system according to the present disclosure can be effectively utilized in time attack events of online and offline shopping malls by using the payment expiration time and the payment amount limit according to the asynchronous payment processing.

The asynchronous payment method according to the present disclosure may be implemented in the form of a recording medium having commands executed by a computer, such as an application or program module executed by the computer. A computer-readable medium may be an arbitrary medium accessible by the computer and include volatile and non-volatile media and separation and non-separation media. Further, the computer-readable medium may include a computer storage medium. The computer storage medium may include volatile and non-volatile media and separation and non-separation media that are executed in arbitrary methods or technologies to store information such as computer-readable commands, data structures, program modules, or data.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. For example, the parts expressed in a singular form may be dispersedly provided, and in the same manner as above, the parts dispersed may be combined with each other.

It is therefore evident that the particular embodiments disclosed above may be altered or modified and all such variations are considered within the scope of the disclosed subject matter. Accordingly, the protection sought herein is as set forth in the claims below.

What is claimed is:

1. An asynchronous payment method based on user-specified payment information, the payment method comprising the steps of:
allowing a user to pre-register information of at least one or more payment types onto a payment server;
allowing the user to select one of the at least one or more payment types whenever the user purchases a product or service in a shop system, to input prearranged payment registration information including payment amount limit and payment expiration time determined according to the product or service to be purchased by him or her to the payment server, and to request prearranged payment registration through which payment is activated with the selected payment type during the payment expiration time;
if a prearranged payment registration serial number matching the prearranged payment registration information is generated and received according to the prearranged payment registration, allowing the user to input the prearranged payment registration serial number to the shop system to request the purchase for the product or service; and
if the prearranged payment registration serial number and payment information including payment amount are transmitted from the shop system to the payment server within the payment expiration time, allowing the payment server to perform payment processing according to whether the prearranged payment registration information matches the payment information.

2. The asynchronous payment method according to claim 1, wherein after the user pre-registers the user's specified payment information as a phrase arbitrarily specified by him or her onto the payment server, in the step of performing the prearranged payment registration if the payment processing with the user-specified payment information is selected, the user inputs the user-specified payment information upon the request of the purchase in the shop system to allow the shop system and the payment server to perform the user identification based on the user-specified payment information.

3. The asynchronous payment method according to claim 1, wherein the payment expiration time is a predetermined fixed time.

4. The asynchronous payment method according to claim 1, wherein in the step of performing the prearranged payment registration, the prearranged payment registration information based on the information provided by the shop system is set.

5. The asynchronous payment method according to claim 4, wherein the payment expiration time is set as the remaining time of an event with time limit that occurs in the shop system.

6. The asynchronous payment method according to claim 4, wherein the payment amount limit is set within the amount required for joining in an event occurring in the shop system.

7. The asynchronous payment method according to claim 4, wherein in the step of performing the prearranged payment registration, the user receives information of at least one or more discount coupons applicable to the product or service to be purchased from the shop system, selects and registers the discount coupon he or she desires to be applied to the product or service, and transmits the information of the selected discount coupon to the shop system upon the payment processing, so that the payment processing in which the selected discount coupon is applied to the payment amount is made.

8. The asynchronous payment method according to claim 1, wherein in the step of performing the prearranged payment registration, the identification information of the shop system is inputted, and after the identification information of the shop system is checked, if the information of the shop system inputted by the user is different from the identification information of the shop system checked, the payment server provides a notification for the user.

9. The asynchronous payment method according to claim 1, wherein if the payment processing is completed, the payment server transmits a payment processing completion response and at least one of delivery address and contact to the shop system.

10. The asynchronous payment method according to claim 1, wherein if the shop system is an offline shop, the prearranged payment registration serial number generated from the payment server is transmitted to the form of QR code to the user, and the user scans the QR code on a terminal of the shop system to request the purchase for the product or service.
